(19) United States
(12) Patent Application Publication
(10) Pub. No.: US 2026/0244866 A1
(43) Pub. Date: Aug. 20, 2026

(54) AUTO CHUNKER

(71) Applicant: Dell Products L.P., Round Rock, TX (US)

(72) Inventors: Rajan Shrestha, Georgetown, TX (US); Yijing Zhou, Austin, TX (US)

(73) Assignee: Dell Products L.P., Round Rock, TX (US)

(21) Appl. No.: 19/055,845

(22) Filed: Feb. 18, 2025

(51) Int. Cl. G06F 40/289

(52) U.S. Cl. CPC G06F 40/289

(57) ABSTRACT

A method, comprising: displaying a user interface for specifying a chunking strategy for a text; receiving, via the user interface, a user input specifying at least a first parameter of the chunking strategy, a second parameter of the chunking strategy, and a third parameter of the chunking strategy, the first parameter being chunk size, the second parameter being a set of one or more break items, and the third parameter being an overlap number; generating a plurality of optimized chunks by dividing the text based on the chunking strategy, each of the plurality of optimized chunks including only full segments, each of the optimized chunks being a string from the text that is delimited by a first instance of one of the break items in the text and a second instance of one of the break items in the text; and storing the plurality of optimized chunks at a predetermined data storage location for use in fine-tuning or enhancing a machine-learning model.

### BACKGROUND

Large Language Models (LLMs) are sophisticated artificial intelligence systems designed to understand, generate, and manipulate human language. Examples of these models include OpenAI's GPT and Google's PaLM. They are constructed using deep learning techniques, particularly transformer architectures, and are trained on extensive datasets of text.

LLMs are capable of performing a wide variety of natural language processing (NLP) tasks, including text generation, translation, summarization, and engaging in conversational interactions. By leveraging statistical patterns in language, these models can produce coherent and contextually relevant responses. As a result, they are valuable for applications in education, customer service, content creation, and more.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: displaying a user interface for specifying a chunking strategy for a text; receiving, via the user interface, a user input specifying at least a first parameter of the chunking strategy, a second parameter of the chunking strategy, and a third parameter of the chunking strategy, the first parameter being chunk size, the second parameter being a set of one or more break items, and the third parameter being an overlap number; generating a plurality of optimized chunks by dividing the text based on the chunking strategy, each of the plurality of optimized chunks including only full segments, each of the optimized chunks being a string from the text that is delimited by a first instance of one of the break items in the text and a second instance of one of the break items in the text; and storing the plurality of optimized chunks at a predetermined data storage location for use in fine-tuning and/or enhancing a machine-learning model, wherein, when the overlap number is greater than zero, generating any given one of the plurality of optimized chunks, other than a first chunk in the plurality of optimized chunks, includes inserting, in the given optimized chunk, N last chunks that are present in another one of the plurality of optimized chunks that immediately precedes the given optimized chunk, where N is the overlap number, and wherein each of the break items includes a character or a concatenation of characters.

According to aspects of the disclosure, a system is provided, comprising: a memory; and at least one processor that is configured to perform the operations of: displaying a user interface for specifying a chunking strategy for a text; receiving, via the user interface, a user input specifying at least a first parameter of the chunking strategy, a second parameter of the chunking strategy, and a third parameter of the chunking strategy, the first parameter being chunk size, the second parameter being a set of one or more break items, and the third parameter being an overlap number; generating a plurality of optimized chunks by dividing the text based on the chunking strategy, each of the plurality of optimized chunks including only full segments, each of the optimized chunks being a string from the text that is delimited by a first instance of one of the break items in the text and a second instance of one of the break items in the text; and storing the plurality of optimized chunks at a predetermined data storage location for use in fine-tuning and/or enhancing a machine-learning model, wherein, when the overlap number is greater than zero, generating any given one of the plurality of optimized chunks, other than a first chunk in the plurality of optimized chunks, includes inserting, in the given optimized chunk, N last chunks that are present in another one of the plurality of optimized chunks that immediately precedes the given optimized chunk, where N is the overlap number, and wherein each of the break items includes a character or a concatenation of characters.

According to aspects of the disclosure, a non-transitory computer-readable medium is provided storing one or more processor-executable instructions, which, when executed by at least one processor, cause the processor to perform the operations of: displaying a user interface for specifying a chunking strategy for a text; receiving, via the user interface, a user input specifying at least a first parameter of the chunking strategy, a second parameter of the chunking strategy, and a third parameter of the chunking strategy, the first parameter being chunk size, the second parameter being a set of one or more break items, and the third parameter being an overlap number; generating a plurality of optimized chunks by dividing the text based on the chunking strategy, each of the plurality of optimized chunks including only full segments, each of the optimized chunks being a string from the text that is delimited by a first instance of one of the break items in the text and a second instance of one of the break items in the text; and storing the plurality of optimized chunks at a predetermined data storage location for use in fine-tuning and/or enhancing a machine-learning model, wherein, when the overlap number is greater than zero, generating any given one of the plurality of optimized chunks, other than a first chunk in the plurality of optimized chunks, includes inserting, in the given optimized chunk, N last chunks that are present in another one of the plurality of optimized chunks that immediately precedes the given optimized chunk, where N is the overlap number, and wherein each of the break items includes a character or a concatenation of characters.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an example of a user interface, according to aspects of the disclosure;

FIG. 3 is a flowchart of an example of a process, according to aspects of the disclosure;

FIG. 4 shows an example of a body of text that is divided into chunks, according to aspects of the disclosure;

FIG. 5 shows an example of a raw chunk, according to aspects of the disclosure;

FIG. 6 shows an example of a raw chunk, according to aspects of the disclosure;

FIG. 7 shows an example of an optimized chunk, according to aspects of the disclosure;

FIG. 8 shows an example of a raw chunk, according to aspects of the disclosure;

FIG. 9 shows an example of a raw chunk, according to aspects of the disclosure;

FIG. 10 shows an example of an optimized chunk, according to aspects of the disclosure;

FIG. 11 shows an example of a raw chunk, according to aspects of the disclosure;

FIG. 12 shows an example of a raw chunk, according to aspects of the disclosure;

FIG. 13 shows an example of an optimized chunk, according to aspects of the disclosure;

FIG. 14 is a diagram of an example of a computing device, according to aspects of the disclosure;

FIG. 15 is a diagram of an example of a use case, according to aspects of the disclosure; and

FIG. 16 is a diagram of an example of a use case, according to aspects of the disclosure.

### DETAILED DESCRIPTION

With the breakthrough of ChatGPT™, generative AI (GenAI) and language models are experiencing explosive growth and momentum in the industry. Practitioners working with various large language models (LLMs) often seek to determine which model is the best fit and most cost-effective for their needs. However, they soon realize that the token size and input limits imposed by different model environments create a practical challenge in the process. Frequently, practitioners are forced to re-chunk the inputs or prompts used to fine-tune new models, which can disrupt what they have previously built. This is problematic because chunking is the initial step in preparing unstructured data for artificial intelligence (AI) applications; every subsequent step relies on the effectiveness of this chunking process. In the context of AI, chunking refers to the process of breaking down large pieces of text or data into smaller, manageable units known as “chunks.” As mentioned earlier, chunking is essential for fine-tuning large language models and providing inputs to Retrieval-Augmented Generation (RAG) processes that are associated with the models. To further illustrate how chunking is applied, a broad overview is provided of the steps necessary to fine-tune or otherwise enhance a machine-learning model, such as a large language model (LLM). First, a relevant text is obtained for fine-tuning (or otherwise enhancing) the model. Next, the text is divided into chunks. Subsequently, the chunks are gfconverted into embeddings, which are then stored in a vector database. And finally, the embeddings are used to fine-tune the machine-learning model or provide context for RAG queries that are associated with the machine-learning model

Different LLM providers utilize distinct embedding formats, resulting in diverse chunking requirements and/or diverse token sizes. For instance, an LLM provider might impose limits on chunk size or prefer specific levels of overlap between consecutive chunks. In general, an LLM provider may offer a framework that customers can use to fine-tune the LLM according to their particular needs. Customers are responsible for chunking their training (or fine-tuning) data and then providing those chunks to the framework, where they are subsequently used to fine-tune the machine-learning model, or as an input to a RAG process that is arranged to provide context to the machine-learning model. In other words, chunking may be performed as a pre-processing step before the training data is used to fine-tune the LLM or to otherwise enhance the performance of the LLM.

As noted, a customer may need to chunk the same data multiple times. This repetition might be motivated by the desire to experiment with different LLMs or various chunking styles to determine the most effective approach for their needs. As noted above, different LLM providers may require different token sizes, which in turn may require the chunk size to be set accordingly for the chunks used to generate the tokens. Regardless of the reasons, the process of chunking data can be time-intensive and demand a significant allocation of human resources. The present disclosure introduces a method and system designed to enhance the efficiency of the splitting and chunking process. This system includes a user interface that allows users to specify various chunking strategies, along with logic to execute these strategies. The method or system can be implemented in hardware, software, or a combination of both.

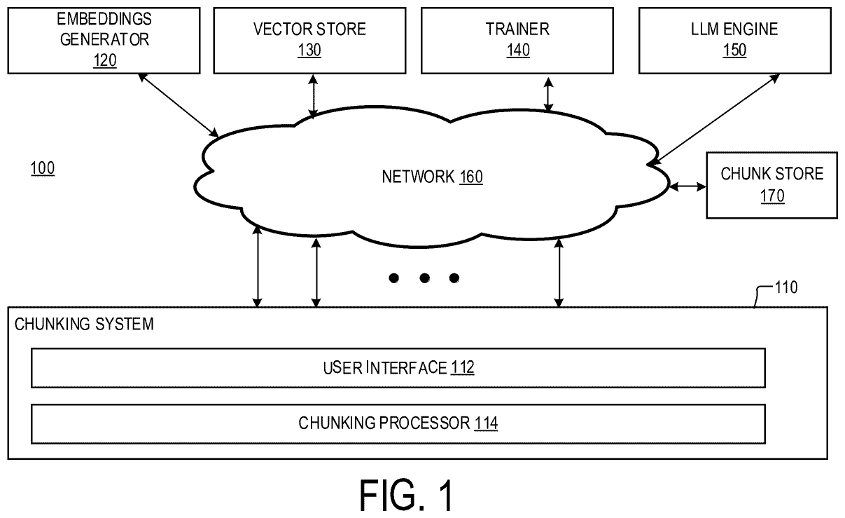

FIG. 1 illustrates an example of a system 100, according to certain aspects of the disclosure. As shown, system 100 comprises a chunking system 110 (hereinafter referred to as “system 110”), an embeddings generator 120 (hereinafter “generator 120”), a vector database 130, a optimizer 140, an LLM engine 150 (hereinafter “engine 150”), and a chunk store 170. In this example, system 110, generator 120, vector database 130, optimizer 140, chunk store 170, and engine 150 are interconnected via a communications network 160. Communications network 160 may include one or more communications networks, such as the Internet, a local area network (LAN), a wide area network (WAN), an InfiniBand network, a wireless network (e.g., a 5G network or 802.11), or any other suitable type of network.

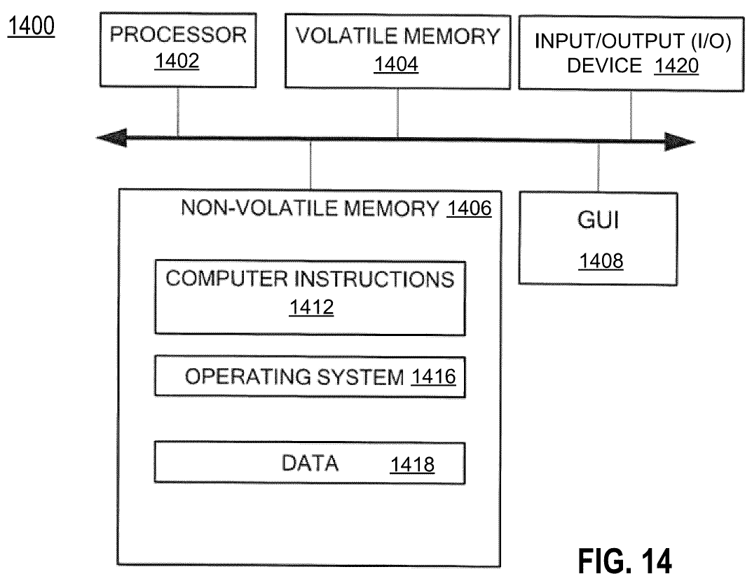

Engine 150 may include one or more computing devices, similar to computing device 1400 shown in FIG. 14. Engine 150 may be configured to run software that executes a machine-learning model. In this example, the machine-learning model is an LLM model, but the disclosure is not limited to this specific type of machine-learning model. Engine 150 can also implement the model in hardware (using one or more neural processors or graphical processing units) or as a combination of software and hardware.

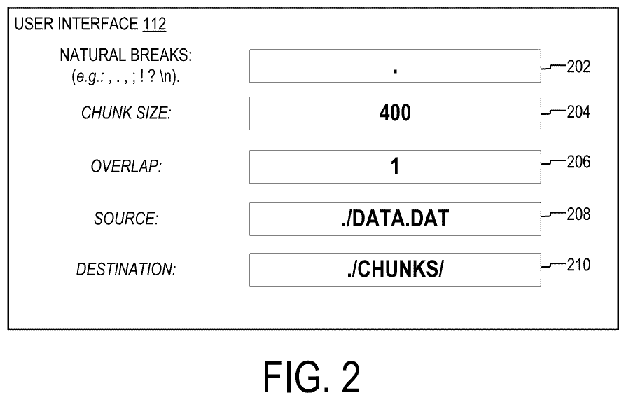

System 110 may comprise one or more computing devices, such as computing device 1400. System 110 may be configured to execute a user interface 112 and a chunking processor 114. User interface 112 may be a command line interface, a voice-based interface, a graphical user interface (GUI), or any other suitable type of user interface. User interface 112 may be arranged to receive user input specifying parameters for a chunking strategy. In one example, the user interface may be configured as discussed further below with respect to FIG. 2. Chunking processor 114 may be configured to divide a text into chunks in accordance with the chunking strategy that is specified via the user interface 112. According to the present example, the text is a natural language text. However, alternative implementations are possible in which the text is another type of data that is encoded using characters. In one example, the text may be encoded in UNICODE or ASCII, but the present disclosure is not limited thereto. In some implementations, the text may be encoded in binary.

Generator 120 may include one or more computing devices, such as computing device 1400. Generator 120 may be configured to execute vector generation software, which receives one or more chunks produced by the chunking system 110 as input. This software generates a plurality of embeddings based on the chunks. The software may comprise tools like text2vec, word2vec, OpenAI's ™ Embeddings Application Programming Interface (API), a sentence transformer, or any other suitable type of software. In one particular example, each chunk may include a block of text (e.g., encoded in ASCII or UNICODE), and each embedding may be a numerical vector or string.

Vector database 130 may include one or more computing devices, such as computing device 1400. Vector database 130 may be configured to implement a database for storing embeddings, a logical unit (like a data volume), or one or more file system folders to store the embeddings generated by generator 120. Optimizer 140 is configured to execute a machine-learning modelRAG process and/or a framework for fine-tuning the machine-learning model. For example, optimizer 140 may execute a framework for fine-tuning the machine-learning model, such as Low-Rank Adaptation (LoRA) or another similar framework. Additionally or alternatively, optimizer 140 can implement the Retrieval-Augmented Generation (RAG) model or similar models to enhance the machine-learning model (operated by engine 150) with external knowledge. machine-learning model

Chunk store 170 may include one or more computing devices, such as computing device 1400. According to the present example, chunk store 170 is configured to execute or otherwise implement a database (e.g., a relational database or non-relational database), a logical unit (e.g., a data volume), or one or more file system folders, where the chunks generated by chunking system 110 are stored. Chunk store 170 is one example of a storage location for storing chunks that are generated by system 110.

According to the example of FIG. 1, the function described with respect to each of blocks 110, 120, 130, 140, 150, and 170 is implemented in software. However, alternative implementations are possible in which the function is implemented in hardware or as a combination of software and hardware. According to the example of FIG. 1, the function described with respect to each of blocks 110, 120, 130, 140, 150, and 170 is executed on a different computing system (e.g., either an integrated or distributed computing system). However, alternative implementations are possible in which all of the functions (or two or more of the functions) are executed on the same computing system.

FIG. 2 is a diagram of the user interface 112, according to aspects of the disclosure. As illustrated, the user interface may include input components 202-210. In this example, each of the input components 202-210 is a text input field. However, alternative implementations are possible, where any of the input components 202 could be a different type of input element, such as a dropdown list, dropdown menu, radio button menu, checkbox menu, toggle switch, drag-and-drop input component, microphone button, or any other suitable input method. This disclosure is not limited to any specific type of input component.

Input component 202 may be configured to receive a user input specifying a set of natural breaks. The user input may be entered by using a keyboard and/or any other suitable type of input device, such as a microphone or a touchpad. In one example, the term “natural break” may refer to any character or set of characters that signify a natural pause in text. For example, a natural break may include a period (full stop), which marks the end of a sentence. Other examples of natural breaks include the colon, semi-colon, or any punctuation mark. Additionally, non-visible characters like the new line character (\n), carriage return character (\r), backspace character (\b), null character (\0), or any other suitable character can also serve as natural breaks. Furthermore, natural breaks could include mathematical symbols (e.g., +, −, *, /), logical comparison operators (e.g., <, >, &, %), special symbols used in natural expressions (e.g., {, (, ), \hat{ }, $), or escape characters. A natural break may also include a concatenation of characters. The specific type of natural break used may depend on the kind of data the chunking system 110 is used to process. For instance, if the data is in natural language text, punctuation marks are typically used to delineate sentences. Conversely, if the text is a table encoded by using a markup language notation, the natural break may be whatever character or set of characters delimitates individual cells or rows in the table. In other words, the present disclosure is not limited to any specific types of natural breaks that can be specified via input component 202, and the meaning of the term “natural” depends on the semantics of the text that is being processed.

Input component 202 may be configured to receive user input specifying a set of natural breaks. The set may include a single natural break or a plurality of natural breaks. As shown in FIG. 2, the set may include only the period character. However, in an alternative implementation, the set may include a plurality of natural breaks, such as the set consisting of the period character, the colon character, the semi-colon character, the exclamation point character, and the new line character, etc.

Input component 204 may be configured to receive user input specifying the chunk size for a chunking strategy. According to one example, the chunk size may specify the maximum number of characters that can be present in any of the chunks generated by system 110. However, in alternative implementations, the chunk size may specify the maximum number of words that can be present in a chunk, or another measure that places a limit on chunk size.

Input component 206 may be configured to receive user input specifying an overlap number. The overlap number may specify how many segments from each of the chunks generated by system 110 must be present in the subsequent chunk. For example, an overlap number of ‘1’ may specify that any given chunk in a sequence, aside from the first one, must begin with the last segment in the chunk preceding the given chunk in the sequence. Similarly, an overlap number of ‘2’ would mean that any given chunk in a sequence, other than the first one, must begin with the last two segments of the previous chunk. An overlap number of ‘0’ may indicate any given chunk in a sequence does not need to include any segments from the preceding chunk. Additionally, when an overlap number is greater than the total number of segments in a preceding chunk, the next chunk may include all segments that are part of the preceding chunk. Thus, in this case, the next chunk may include N chunks, where N is the lesser of the overlap number or the total number of segments in the preceding chunk.

A segment may be an alphanumerical string that is delimited by a first instance of a natural break (specified via input component 202) and a second instance of a natural break (specified via input component 202). The segment may or may not include any of the natural breaks that delimit it or any spaces that follow the natural breaks. The first and second instances may be instances of the same natural break (e.g., they both may be different period characters that occur in a text). Alternatively, the first and second instances may be instances of different natural breaks (e.g., one may be a period in the text, and the other one may be an exclamation point).

Input component 208 may be configured to receive user input specifying the location of a text that is being divided into chunks by system 110. For example, input component 208 may be used to specify a storage folder containing one or more files that include the text, a database containing the text, or a database portion where the text is stored.

Input component 210 may be configured to receive user input specifying the storage location where the chunks generated by system 110 are stored. Similar to input component 208, input component 210 may be used to specify a storage folder, a database, or a database portion where the chunks are going to be stored.

FIG. 2 is provided as an example only. In some implementations, one or more of input components 202-210 may be omitted from user interface 112. Although, in the present example, user interface 112 is a graphical user interface, alternative implementations are possible in which user interface 112 is a command line interface. In the case of a command line interface, displaying the user interface may include displaying a prompt for the user to enter one or more of the information items discussed above with respect to FIG. 2.

In one aspect, the user interface allows the user to specify an overlap number. The degree of overlap between consecutive chunks can significantly impact the performance of a machine-learning model fine-tuned with these chunks. This feature of user interface 112, which allows users to input an overlap number, is beneficial as it enables users to experiment with various levels of overlap until they identify the amount that works best for their needs.

Furthermore, the pricing models adopted by LLM providers for the fine-tuning of LLMs depend on the number of tokens (or chunks processed). Thus, the feature of user interface 112 which allows user to change the chunk size, and with this to indirectly change the number of tokens, allows users to find the ratio between chunk size (or number of tokens) and cost which works best for their needs.

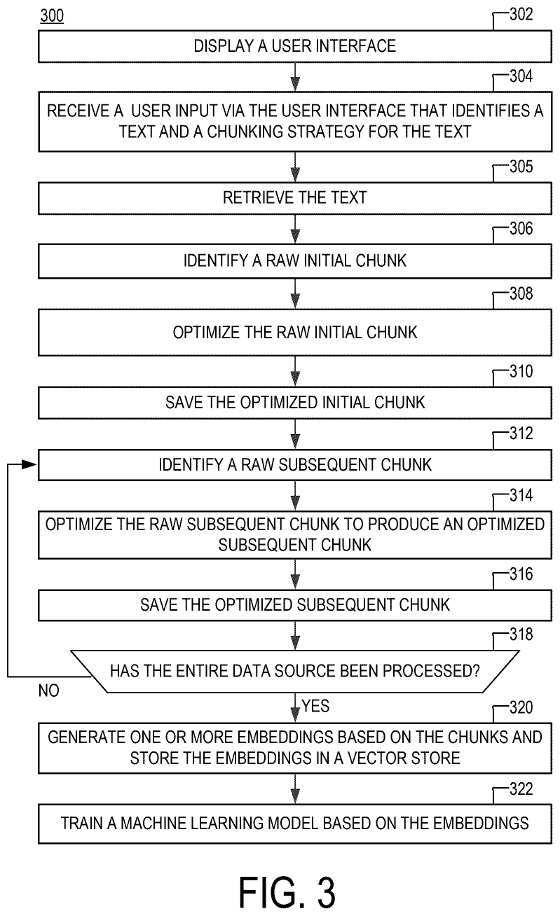

FIG. 3 illustrates a flowchart of an example of a process 300 according to various aspects of this disclosure. In this example, process 300 is executed by a chunking processor 114. However, it should be noted that the present disclosure is not limited to any specific entity or group of entities performing process 300.

At step 302, the user interface 112 is displayed on a display device of system 110.

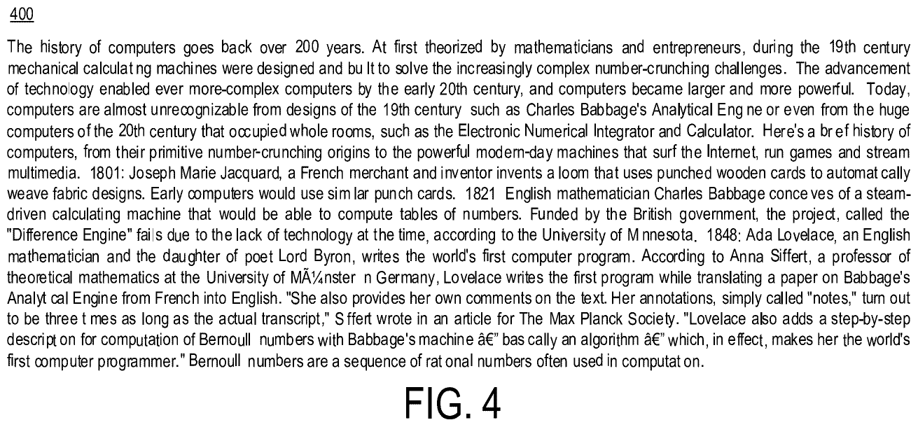

At step 304, chunking processor 114 receives user input that identifies a text and a chunking strategy. In this example, user interface 112 is configured as discussed in relation to FIG. 2. The user input is received through input components 202-210 (shown in FIG. 2). The input specifies a file containing the text 400, depicted in FIG. 4. The file is identified by its filename and file path, which indicate the storage location. In this case, text 400 is the content to be divided into chunks based on the specified chunking strategy. The chunking strategy (and/or user input) may include one or more of the following: (i) an indication of the maximum number of characters allowed in each chunk or another measure of maximum chunk size, (ii) an indication of the overlap number, and (iii) a set of one or more natural breaks that will be utilized to divide text 400 into chunks and/or define the segments within each chunk. In this example, the maximum number of characters is set by the user input at 400, the set of natural breaks provided as user input consists solely of the period character, and the overlap number provided with the user input includes the number ‘1,’ meaning that only one segment must be shared between consecutive chunks.

At step 305, text 400 is retrieved from permanent storage and loaded into a buffer in random access memory.

At step 306, a raw initial chunk is identified. This initial chunk consists of a portion of text 400, starting from the first character and containing no more than the maximum number of characters specified at step 304 (i.e., 400 characters in this example). Identifying the raw initial chunk involves: (i) determining a starting index (SI) for the raw initial chunk, (ii) determining an ending index (EI) for the raw initial chunk, and (iii) extracting from the text (as identified at step 304) a sequence of characters that begins with the character at the starting index SI and ends with the character at the ending index EI. At step 306, SI is set to 0, EI is set to 400 (the chunk size defined at step 304), which results in the first four-hundred characters being extracted from text 400 as the raw initial chunk. Examples of further definitions for the starting and ending indices, as well as character indexing, are provided later in this discussion.

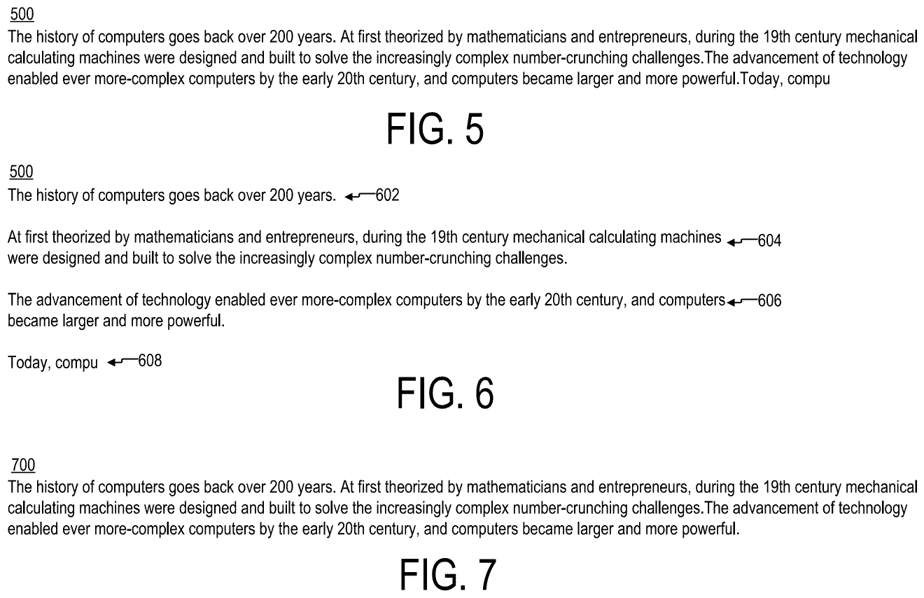

According to this example, the raw initial chunk corresponds to chunk 500, as shown in FIGS. 5-6. Chunk 500 may include segments 602, 604, 606, and 608, where segments 602, 604, and 606 are full segments, and segment 608 is a partial segment. In the terminology of this disclosure, a partial segment is defined as a string that starts after one of the natural breaks (specified at step 304) but does not end with (or at) one of those natural breaks. In other words, a partial segment is truncated due to the maximum chunk size limit. Full segments, on the other hand, are strings that start after one of the natural breaks in text 400 and end with one of those natural breaks. Depending on the implementation, the natural breaks at the start and end of the string may or may not be considered part of the segment.

At step 308, the raw initial chunk (identified at step 306) is optimized. This optimization involves removing any partial segments from the raw initial chunk. An optimized chunk contains only full segments, meaning no partial segments are included. In this example, optimizing chunk 500 involves removing partial segment 608 to produce chunk 700, as shown in FIG. 7. Chunk 700 (the optimized chunk) includes only full segments, specifically segments 602, 604, and 606.

Under the nomenclature of the present disclosure, segment 606 is the last segment in chunk 700, segment 604 is the second-to-last segment in chunk 700, and segment 602 is the first segment in chunk 700. In general, the last segment in a chunk is the one that is farthest from the beginning of the text that is divided into chunks (e.g., text 400), while the first segment in the chunk is the one closest to the beginning of the text.

As can be readily understood, text 400 can be viewed as an ordered sequence of segments. In this regard, under the nomenclature of the present disclosure, a leading segment in a proper subset of the sequence is one of the segments in that subset that is closest to the beginning of the text to which the segments belong. For example, in the subset of segments consisting entirely of segments 602, 604, and 606, segment 602 is the leading segment. In the subset consisting entirely of segments 604 and 606, segment 604 is the leading segment. In a subset consisting solely of segment 606, segment 606 is the leading segment.

Additionally, text 400 may also be viewed as an ordered sequence of characters. Each character may have a different respective character index. The character index refers to the position of any character within the sequence of characters that constitutes the text. Therefore, the phrase “index of a character” or “character index” refers to the position of the character within the entire text being chunked, rather than its position in a particular chunk or segment.

Under the nomenclature of the present disclosure, the starting index (SI) of a chunk is defined as the character index of the first character in that chunk. In contrast, the ending index (EI) of a chunk is the character index of the last character in the chunk. Similarly, the starting index of a segment is the character index of the first character in that segment, and the ending index of the segment is the character index of the last character in that segment.

At step 310, the initial optimized chunk is saved. For example, saving the initial optimized chunk may involve storing it in chunk store 170. This could include generating an object that contains a sequence number for the chunk, which denotes the order in which the chunk was created. In this case, the sequence number for the optimized initial chunk is ‘0’. Alternatively, saving the chunk may involve storing the chunk along with the sequence number in a database, ensuring that the sequence number is mapped to the chunk within the database. In some implementations, the ordering of chunks may be implicit, either in the order in which they are stored in chunk store 170 or provided in their file/object names. The term “ordering of chunks” refers to the order in which the chunks appear in the text. In many instances, this order is important, and information identifying the order may need to be passed to optimizer 140 when embeddings corresponding to the chunks are used by optimizer 140 to fine-tune the natural language model implemented on engine 150.

At step 312, a raw subsequent chunk is identified. Identifying the raw subsequent chunk may include: (i) determining a starting index (SI) for the subsequent chunk, (ii) identifying the end index (EI) of the raw subsequent chunk, and (iii) extracting a sequence of characters from the text (identified at step 304) that starts with the character at the starting index SI and ends with the character at the ending index EI. Identifying the starting index of the raw subsequent chunk may include: (i) identifying the most recently created optimized chunk from process 300 prior to the current execution of step 312, (ii) determining the last N full segments in the identified optimized chunk, where N is the overlap number specified at step 304, (iii) identifying the leading segment among these N last full segments, (iv) determining the starting index of the leading segment, and (v) setting the value of SI to the starting index of the leading segment. The end index EI of the raw subsequent chunk can be determined using the equation EI=SI+max, where max is the chunk size specified at step 304 or a number that is less than the chunk size. The number max may be equal to or otherwise determined based on the chunk size. As illustrated in FIG. 3, steps 312-316 are executed iteratively. In the first iteration of step 312, the most recently created optimized chunk will be the optimized initial chunk (created at step 310). In each subsequent iteration of step 312, the most recently created optimized chunk will be the one generated in the last previous iteration of step 316 (i.e., the iteration of step 316 that was most recently executed). The phrase “character at the starting index SI” may refer to the character having a character index equal to SI. The phrase “character at the ending index EI” may refer to the character having a character index equal to EI.

At step 314, the raw subsequent chunk is optimized to generate an optimized subsequent chunk. The optimized subsequent chunk may be obtained by removing any partial segments that may be present in the raw subsequent chunk. If the raw subsequent chunk does not contain any partial segments, the optimized subsequent chunk will be identical to the raw subsequent chunk.

At step 316, the optimized subsequent chunk is saved. In one example, saving the optimized subsequent chunk may involve storing it in chunk store 170. The chunk may be saved to permanent storage as a file, as a database object, and/or in any other suitable manner. Additionally, this process may include generating an object that contains a sequence number for the chunk, which identifies the order in which the chunk was created. In this example, the sequence number for the optimized subsequent chunk is equal to the number of the iteration of steps 312-314 in which the optimized subsequent chunk is generated. If the chunk is generated in the first iteration, the sequence number would be ‘1’, if the chunk is generated in the second iteration, the sequence number would be ‘2’, and so forth. Alternatively, saving the chunk may involve storing both the chunk and its sequence number in a database where the sequence number is associated with the corresponding chunk. Furthermore, as noted above, the sequence number of the chunk may be implied by the temporal order in which the chunk is stored in chunk store 170 or included in the file/object name given to the chunk. Additionally or alternatively, each of the chunks may be saved as one of a separate object, a separate file, a separate object portion, or a separate file portion.

At step 318, a determination is made regarding whether the entire text (identified at step 304) has been processed. If the entire text has been processed, process 300 proceeds to step 320. If it has not, process 300 returns to step 312. In this context, the entire text is considered processed if the end index of the last optimized subsequent chunk created matches the character index of the last character in the text.

At step 320, one or more embeddings are generated based on the chunks created in steps 306-316. Each embedding may be generated by generator 120 based on a different one of the chunks. This process may involve transmitting an instruction from chunking processor 114 to generator 120, requesting the creation of embeddings. The instruction can be sent using a method for interprocess communication or by calling an API provided by generator 120. Upon receiving the instruction, generator 120 creates the embeddings in a well-known manner, after which it stores the embeddings in vector database 130 and returns an acknowledgment to chunking processor 114.

At step 322, the one or more embeddings are used to fine-tune the machine-learning model provided by engine 150 and/or provide inputs to a RAG processes that is used to enhance the machine-learning model. In this example, chunking processor 114 may transmit an instruction to optimizer 140 to fine-tune the machine-learning model. This instruction can also be sent via interprocess communication or by calling an API provided by optimizer 140. Upon receiving the instruction, optimizer 140 may fine-tune the machine-learning model in a well-known manner.

In the example illustrated in FIG. 3, the chunking processor operates as an orchestrator. However, in alternative implementations, a separate orchestrator may be included in system 100. This orchestrator can be executed on a computing device, such as computing device 1400, and it can manage the operations of chunking processor 114, generator 120, and optimizer 140 as discussed above.

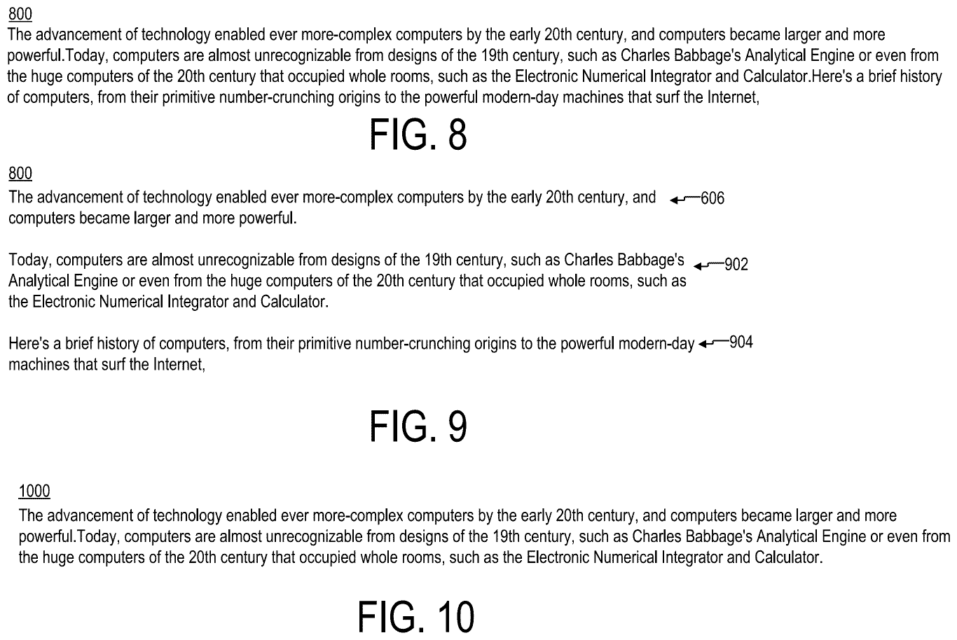

FIGS. 8 and 9 illustrate an example of a raw subsequent chunk 800 identified during the first iteration of step 312. As shown, chunk 800 consists of full segments 606 and 902, along with a partial segment 904. FIG. 10 presents an example of an optimized subsequent chunk 1000 generated in the first iteration of steps 314 and 316. This optimized chunk 1000 is derived from chunk 800. The optimization process involves removing any partial segments present in chunk 800. Consequently, chunk 1000 consists of segments 606 and 902 but excludes the partial segment 904 that was part of chunk 800. It will be recalled, that the natural breaks specified at step 304 include only the period character—in this regard, the comma character at the end of segment 904 is not a natural break in the present example.

Additionally, FIG. 10 highlights the overlap between chunk 1000 and the previously optimized chunk 700 (shown in FIG. 7). The overlap is manifested by the last segment in chunk 700 (segment 606) being incorporated as the first segment in chunk 1000. In this instance, only the last segment from the preceding chunk (chunk 700) is incorporated at the beginning of the next chunk (chunk 1000) because the overlap number—obtained in step 304—is equal to 1. If the overlap number had been 2 or 3, the last two or three segments from chunk 700 would have been included in chunk 1000, etc.

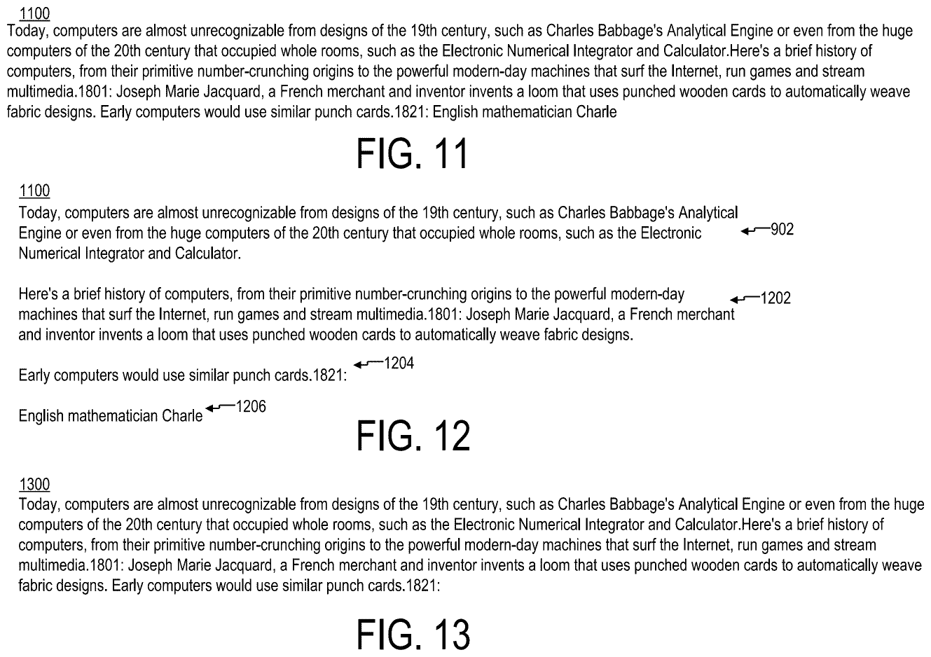

FIGS. 11 and 12 depict a raw subsequent chunk 1100 identified during the second iteration of step 312. As illustrated, chunk 1100 contains full segments 902, 1202, and 1204, along with a partial segment 1206. FIG. 13 shows an example of an optimized subsequent chunk 1300 generated in the second iteration of steps 314 and 316. This optimized chunk 1300 is created by refining chunk 1100, which includes the removal of any partial segments. As a result, chunk 1300 features full segments 902, 1202, and 1204, but omits the partial segment 1206.

Furthermore, FIG. 13 also illustrates the overlap between chunk 1300 and the previously optimized chunk 1000 (shown in FIG. 7). In this case, the overlap is manifested by the last segment of chunk 1000 (segment 902) serving as the first segment in chunk 1300. Similarly to the previous example, only the last segment from the preceding chunk (chunk 1000) is included at the beginning of chunk 1300 because the overlap number—obtained in step 304—is again equal to 1. If the overlap number had been 2 or 3, the last two or three segments from chunk 1000 would have been incorporated into chunk 1300, etc.

FIGS. 3-13 provide an example of one possible process for generating optimized chunks. However, the present disclosure is not limited to any specific process for generating optimized chunks. In an alternative implementation, chunking processor 114 may receive, as input, a text as well as the other input discussed above with respect to step 304. Next, chunking processor 114 may scan the text to identify each of the full segments that are part of the text, along with the full segment's size (e.g., the number of characters in the segment). Next, chunking processor 114 may generate a plurality of optimized chunks by packing in each of the chunks as many consecutive full segments as would fit into the chunk without exceeding the limit on chunk size. For example, the chunks may be identified by executing the following steps: (i) scan the text to identify each of the full segments that form the text, (ii) identify the respective size of each of the segments, (iii) initialize a chunk a current_size variable for the chunk, and a variable temp, (iv) select one of the full segments as a starting segment of chunk, (v) increment current size by the size of the full segment selected at step (iv) or step (ix), (vi) identify the next consecutive full segment in the text, (vii) set temp to equal the sum of current_size and the size of the next consecutive full segment, (viii) determine if temp is greater than the maximum permitted chunk size), (ix) if temp is not greater than the maximum permitted chunk, include the next full segment into the chunk and return to step (v), (x) if temp is greater than the maximum permitted chunk size, finalize the chunk and return to step (iii). Steps (iii)-(x) may be performed until the entire text is processed. The starting segment in each chunk, other than the first, may be selected in accordance with the overlap number as discussed above. The initial scan performed at steps (i) and (ii) may result in the generation of a data structure that identifies the starting and ending indices of each full segment, as well as its size. This data structure may be subsequently used as a basis for the selection/identification of full segments, at steps (iv) and (vi), as well as a basis for determining the sizes of the full segments.

Referring to FIG. 14, in some embodiments, a device 1400 may include processor 1402, volatile memory 1404 (e.g., RAM), non-volatile memory 1406 (e.g., a hard disk drive, a solid-state drive such as a flash drive, a hybrid magnetic and solid-state drive, etc.), graphical user interface (GUI) 1408 (e.g., a touchscreen, a display, and so forth) and input/output (I/O) device 1420 (e.g., a mouse, a keyboard, etc.). Non-volatile memory 1406 stores computer instructions 1412, an operating system 1416 and data 1418 such that, for example, the computer instructions 1412 are executed by the processor 1402 out of volatile memory 1404. Program code may be applied to data entered using an input device of GUI 1408 or received from I/O device 1420.

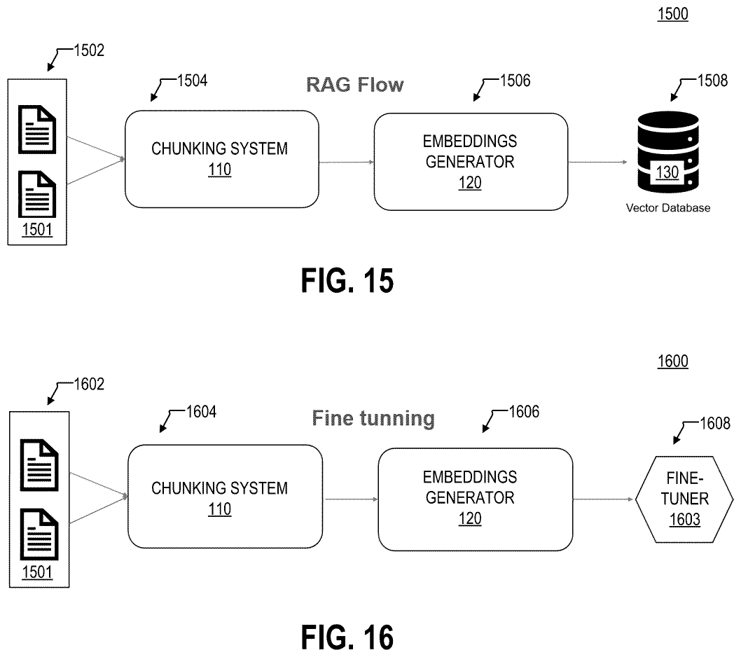

FIG. 15 is a diagram of an example of a use case 1500, in which the output of the chunking system 110 is used as input to a RAG process used to enhance the operation of a machine-learning model (e.g., an LLM). At step 1502, a dataset 1501 is provided as input to chunking system 100. The dataset 1501 may include a single body of text or a plurality of bodies of text. The dataset may be contained in one or more files, etc. At step 1504, chunking system 110 divides the dataset 1501 into a plurality of optimized chunks. At step 1506, embeddings generator 120 generates a plurality of embeddings based on the chunks. And at step 1508, the embeddings are stored in vector database 130, from where they can be retrieved by a RAG process that is executed on optimizer 140 and used to enhance the machine-learning model provided by engine 150.

FIG. 16 is a diagram of an example of a use case 1600, in which the output of the chunking system 110 is used as input to a fine-tuning framework that is used to fine-tune a machine-learning model (e.g., an LLM). At step 1602, the dataset 1501 is provided as input to chunking system 100. At step 1604, chunking system 110 divides the dataset 1501 into a plurality of optimized chunks. At step 1606, embeddings generator 120 generates a plurality of embeddings based on the chunks. And at step 1608, the embeddings are provided to fine-tuning framework 1603 which may be executed on optimizer 140, and used to fine-tune the machine-learning model provided by engine 150.

FIGS. 1-16 are provided as an example only. In some embodiments, the term “I/O request” or simply “I/O” may be used to refer to an input or output request. At least some of the steps discussed with respect to FIGS. 1-16 may be performed in a different order, in parallel, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. The term “text” may refer to a natural language text or any other suitable type of text. In general, the term text may refer to a sequence of characters. A text may include non-visible characters such as newline characters or space characters. The characters may be alphanumerical characters or just numbers. As noted above, in one example, the text may be a natural langauge text such as an a book, or an excerpt from an online forum. In another example, the term text may refer to a (large) sequence of 1s and 0s (e.g., bit sequence). The sequence may encode an image or other information. The method discussed with respect to FIG. 3 may process the sequence as natural language text, using string and character extraction techniques (as would natural language text) without decoding the information that is encoded by the sequence.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
displaying a user interface for specifying a chunking strategy for a text;
receiving, via the user interface, a user input specifying at least a first parameter of the chunking strategy, a second parameter of the chunking strategy, and a third parameter of the chunking strategy, the first parameter being chunk size, the second parameter being a set of one or more break items, and the third parameter being an overlap number;
generating a plurality of optimized chunks by dividing the text based on the chunking strategy, each of the plurality of optimized chunks including only full segments, each of the optimized chunks being a string from the text that is delimited by a first instance of one of the break items in the text and a second instance of one of the break items in the text; and
storing the plurality of optimized chunks at a predetermined data storage location for use in fine-tuning and/or enhancing a machine-learning model,
wherein, when the overlap number is greater than zero, generating any given one of the plurality of optimized chunks, other than a first chunk in the plurality of optimized chunks, includes inserting, in the given optimized chunk, N last chunks that are present in another one of the plurality of optimized chunks that immediately precedes the given optimized chunk, where N is the overlap number, and
wherein each of the break items includes a character or a concatenation of characters.

2. The method of claim 1, further comprising generating a plurality of raw chunks of the text based on the chunking strategy, each of the raw chunks having a size that is no larger than the chunk size, wherein any of the plurality of optimized chunks is generated based on a different one of the raw chunks by removing any partial segment that is present in the raw chunk.

3. The method of claim 1, wherein the plurality of optimized chunks is generated at least in part by scanning the text to identify each full segment in the text, identifying a respective size of each of the full segments, and packing in each of the optimized chunks as many consecutive full segments that would fit without exceeding the chunk size.

4. The method of claim 1, wherein N is equal to the lesser of the overlap number and a total count of segments that are present in the other chunk.

5. The method of claim 1, wherein the first instance and the second instance are different instances of the same break item.

6. The method of claim 1, wherein the first instance and the second instance are instances of different break items.

7. The method of claim 1, wherein the set includes a plurality of break items.

8. The method of claim 1, wherein at least one of the break items includes a non-visible character.

9. The method of claim 1, wherein at least one of the break items incudes one of a punctuation character, a logical comparison operator, or a comparison symbol.

10. A system, comprising:
a memory; and
at least one processor that is configured to perform the operations of:
displaying a user interface for specifying a chunking strategy for a text;
receiving, via the user interface, a user input specifying at least a first parameter of the chunking strategy, a second parameter of the chunking strategy, and a third parameter of the chunking strategy, the first parameter being chunk size, the second parameter being a set of one or more break items, and the third parameter being an overlap number;
generating a plurality of optimized chunks by dividing the text based on the chunking strategy, each of the plurality of optimized chunks including only full segments, each of the optimized chunks being a string from the text that is delimited by a first instance of one of the break items in the text and a second instance of one of the break items in the text; and
storing the plurality of optimized chunks at a predetermined data storage location for use in fine-tuning and/or enhancing a machine-learning model,
wherein, when the overlap number is greater than zero, generating any given one of the plurality of optimized chunks, other than a first chunk in the plurality of optimized chunks, includes inserting, in the given optimized chunk, N last chunks that are present in another one of the plurality of optimized chunks that immediately precedes the given optimized chunk, where N is the overlap number, and
wherein each of the break items includes a character or a concatenation of characters.

11. The system of claim 10, wherein:
the at least one processor is configured to generate a plurality of raw chunks of the text based on the chunking strategy, each of the raw chunks having a size that is no larger than the chunk size, and
any of the plurality of optimized chunks is generated based on a different one of the raw chunks by removing any partial segment that is present in the raw chunk.

12. The system of claim 10, wherein the plurality of optimized chunks is generated at least in part by scanning the text to identify each full segment in the text, identifying a respective size of each of the full segments, and packing in each of the optimized chunks as many consecutive full segments that would fit without exceeding the chunk size.

13. The system of claim 10, wherein N is equal to the lesser of the overlap number and a total count of segments that are present in the other chunk.

14. The system of claim 10, wherein the first instance and the second instance are different instances of the same break item.

15. The system of claim 10, wherein the first instance and the second instance are instances of different break items.

16. The system of claim 10, wherein the set includes a plurality of break items.

17. The system of claim 10, wherein at least one of the break items includes a non-visible character.

18. The system of claim 10, wherein at least one of the break items incudes one of a punctuation character, a logical comparison operator, or a comparison symbol.

19. A non-transitory computer-readable medium storing one or more processor-executable instructions, which, when executed by at least one processor, cause the processor to perform the operations of:
displaying a user interface for specifying a chunking strategy for a text;
receiving, via the user interface, a user input specifying at least a first parameter of the chunking strategy, a second parameter of the chunking strategy, and a third parameter of the chunking strategy, the first parameter being chunk size, the second parameter being a set of one or more break items, and the third parameter being an overlap number;
generating a plurality of optimized chunks by dividing the text based on the chunking strategy, each of the plurality of optimized chunks including only full segments, each of the optimized chunks being a string from the text that is delimited by a first instance of one of the break items in the text and a second instance of one of the break items in the text; and
storing the plurality of optimized chunks at a predetermined data storage location for use in fine-tuning and/or enhancing a machine-learning model,
wherein, when the overlap number is greater than zero, generating any given one of the plurality of optimized chunks, other than a first chunk in the plurality of optimized chunks, includes inserting, in the given optimized chunk, N last chunks that are present in another one of the plurality of optimized chunks that immediately precedes the given optimized chunk, where N is the overlap number, and
wherein each of the break items includes a character or a concatenation of characters.

20. The non-transitory computer-readable medium of claim 15, wherein:
wherein the one or more processor-executable instructions, when executed by the at least one processor, further cause the at least one processor to generate a plurality of raw chunks of the text based on the chunking strategy, each of the raw chunks having a size that is no larger than the chunk size, and
any of the plurality of optimized chunks is generated based on a different one of the raw chunks by removing any partial segment that is present in the raw chunk.
